(19) United States
(12) Patent Application Publication
(10) Pub. No.: US 2024/0401759 A1
(43) Pub. Date: Dec. 5, 2024

(54) IMITATION-SHAPED LAMP

(71) Applicants: Yecheng Lao, Shenzhen (CN); Weiping Huang, Shenzhen (CN); Weihong Liu, Shenzhen (CN)

(72) Inventors: Yecheng Lao, Shenzhen (CN); Weiping Huang, Shenzhen (CN); Weihong Liu, Shenzhen (CN)

(21) Appl. No.: 18/677,939

(22) Filed: May 30, 2024

(30) Foreign Application Priority Data
May 30, 2023 (CN) 2023213532720
Aug. 10, 2023 (CN) 2023221590944

(51) Int. Cl. F21S 2/00; F21V 17/02; F21Y 103/10

(52) U.S. Cl. CPC F21S 2/005; F21V 17/02; F21Y 2103/10

(57) ABSTRACT

An imitation-shaped lamp includes a supporting portion, an illuminating portion, and an imitation-shaped portion detachably coupled at the supporting portion for forming an outer contour of the imitation-shaped lamp, and at least partially covering the illuminating portion. The supporting portion is at least partially located inside the imitation-shaped portion, in order to increase the structural strength of the imitation-shaped portion and shape the outer contour of the imitation-shaped portion. The imitation-shaped lamp is capable of being easily and quickly disassembled, reassembled, shaped and reshaped without causing damage.

### BACKGROUND OF THE PRESENT INVENTION

### Field of Invention

The present invention relates to a lamp, and more particularly to an imitation-shaped lamp, wherein the imitation-shaped lamp is configured for being easily and quickly shaped, which facilitates its disassembly and assembly.

### Description of Related Arts

Imitation-shaped lamps increasingly favored by people for bringing a natural ambiance to artificial environments, are being widely applied in areas such as home decoration, shopping malls, and office spaces.

With the development of society, people's lives are increasingly distant from nature. As aluminous decorative lamps, imitation-shaped lamps, with their lifelike shapes, allow people to feel the natural atmosphere in artificial environments. They are increasingly favored and widely used in home decoration, shopping malls, office spaces, and other fields.

However, related imitation-shaped lamps typically involve pasting aluminum foil on walls or ceilings and then sticking cotton clusters onto the aluminum foil. When attaching the cotton clusters, glue or candle glue is usually required, making the manufacturing process complex and irreversible. Moreover, pasting aluminum foil on walls or ceilings not only increases labor intensity but also damages the walls or ceilings when removing the imitation-shaped lamp. Pasting cotton clusters on walls or ceilings is inconvenient and increases labor intensity. The cotton clusters are not firm, they fall off easily, and the imitation-shaped lamp as a whole also falls off easily. Such installation methods not only require a lot of manual effort to shape the imitation-shaped lamp but also result in shapes with poor structural strength and stability.

It can be seen that how to conveniently and quickly shape imitation-shaped lamp, provide a hard structural strength and stability and facilitate the assembly and disassembly of imitation-shaped lamp is an urgent technical problem to be solved.

### SUMMARY OF THE PRESENT INVENTION

The invention is advantageous in that it provides an imitation-shaped lamp, wherein the imitation-shaped lamp comprises a supporting portion, an illuminating portion, and an imitation-shaped portion detachably coupled at the supporting portion for forming an outer contour of the imitation-shaped lamp, and at least partially covering the illuminating portion. The supporting portion is at least partially located inside the imitation-shaped portion, in order to increase the structural strength of the imitation-shaped portion and shape the outer contour of the imitation-shaped portion.

Optionally, the imitation-shaped lamp further comprising a restricting portion coupled with the supporting portion, and the restricting portion is located outside the contour of the imitation-shaped portion to restrict the shape of the imitation-shaped portion

Optionally, the restricting portion is movably connected to the supporting portion and moves relative to the supporting base.

Optionally, the supporting portion comprises a base and a fixing portion connected to the base and at least partly inserted into the imitation-shaped portion.

Optionally, the base comprises a plurality of supporting holes, and the fixing member comprises a plurality of fixing legs inserted into a corresponding supporting hole.

Optionally, each of the fixing legs comprises a stopper element inserted into the corresponding supporting hole of the base and a main body coupled with the stopper element for supporting the imitation-shaped portion.

Optionally, some of the fixing legs comprises a stopper element and a pair of main bodies attached on both sides of the stopper element.

Optionally, the imitation-shaped portion is positioned on both sides of the base.

Optionally, the stopper element comprises a fastening hole and an end portion of the main body is a chamfered portion inserted into the fastening hole.

Optionally, the stopper element comprises a cylinder portion and a seating portion, the diameter of the cylinder portion fits the corresponding supporting hole of the base, while the diameter of the seating portion is larger than the diameter of the corresponding supporting hole.

Optionally, the outer wall of the cylinder portion is provided with a groove for engaging with an edge of the corresponding supporting hole.

Optionally, the main body is integrally formed with the stopper element.

Optionally, the base has a mesh-like structure.

Optionally, the supporting portion comprises at least two second supporting arms and a first supporting arm interlaced with each of the second supporting arms.

Optionally, the supporting portion comprises a hollow structure and the illuminating portion received in the hollow structure.

Optionally, the imitation-shaped portion can be made of foam, sponge, cotton, or sprayed cotton in various combinations.

Optionally, the imitation-shaped portion creates a cloud-like appearance.

After assembling the imitation-shaped lamp, it can be installed on a specific-shaped structural component, allowing for easy and quick disassembly and assembly without causing damage. Therefore, the imitation-shaped lamp can be easily and quickly shaped, facilitating its disassembly and assembly.

Still further objects and advantages will become apparent from a consideration of the ensuing description and drawings. These and other objectives, features, and advantages of the present invention will become apparent from the following detailed description, the accompanying drawings, and the appended claims.

### BRIEF DESCRIPTION OF THE DRAWINGS

FIG. 1 is an illustrative isometric view of an imitation-shaped lamp according to a first embodiment of the present invention.

FIG. 2 is an illustrative isometric view of the imitation-shaped lamp shown in FIG. 1, and an imitation-shaped portion removed.

FIG. 3 is an illustrative isometric view of the imitation-shaped lamp shown in FIG. 1, with an imitation-shaped portion removed, illustrating another mode of a supporting portion.

FIG. 4 is an illustrative isometric view of a fixing leg and a restricting part of the imitation-shaped lamp shown in FIG. 1.

FIG. 5 is an exploded perspective view of a fixing leg and a restricting part of the imitation-shaped lamp shown in FIG. 1, illustrating another mode of a fixing leg.

FIG. 6 is an illustrative isometric view of a fixing leg and a restricting part of an imitation-shaped lamp according to a second embodiment of the present invention.

FIG. 7 is an illustrative isometric view of a supporting portion of an imitation-shaped lamp according to a third embodiment of the present invention.

FIG. 8 is an illustrative isometric view of the imitation-shaped lamp shown in FIG. 7, with a part of an imitation-shaped portion removed.

FIG. 9 is an illustrative isometric view of a supporting portion of an imitation-shaped lamp according to a fourth embodiment of the present invention.

FIG. 10 is an illustrative isometric view of the imitation-shaped lamp shown in FIG. 9, with a part of an imitation-shaped portion removed.

FIG. 11 is an illustrative isometric view of an imitation-shaped lamp according to a fifth embodiment of the present invention, and a part of an imitation-shaped portion removed.

FIG. 12 is an illustrative isometric view of a supporting portion and an illuminating portion of the imitation-shaped lamp shown in FIG. 11, illustrating another mode of the supporting portion.

FIG. 13 is an illustrative isometric view of the imitation-shaped lamp shown in FIG. 11, illustrating a third mode of the supporting portion.

FIG. 14 is an illustrative isometric view of a supporting portion and an illuminating portion of the imitation-shaped lamp shown in FIG. 11, illustrating a fourth mode of the supporting portion.

### DETAILED DESCRIPTION OF THE PREFERRED EMBODIMENTS

It should be clear that the described embodiments are only a part of the embodiments of the present application, but not all of the embodiments. Based on the embodiments in the present application, all other embodiments obtained by those of ordinary skill in the art without creative efforts shall fall within the protection scope of the present application.

The terms used in the embodiments of the present application are only for the purpose of describing specific embodiments, and are not intended to restrict the present application. The singular forms “a”, “an” and “the” used in the embodiments of the present application and the appended claims are also intended to include the plural forms, unless the context clearly dictates otherwise.

It should be understood that the term “and/or” used in this document is only an association relationship to describe associated objects, indicating that there may be three kinds of relationships. For example, A and/or B may indicate three cases of A alone, A and B, and B alone. In addition, the character “/” in this document generally indicates that the related objects are in an “or” relationship.

It should be noted that the directional words such as “up”, “down”, “left” and “right” described in the embodiments of the present application are described from the angles shown in the drawings, and should not be construed as implementing the embodiments of the present application. In this context, it should also be understood that, when it is mentioned that an element is connected to an “upper” side or a “lower” side of the other element, it may not only be directly connected to the “upper” side or the “lower” side of the other element, but also be indirectly connected to the “upper” side or the “lower” side of the other element through an intermediate element.

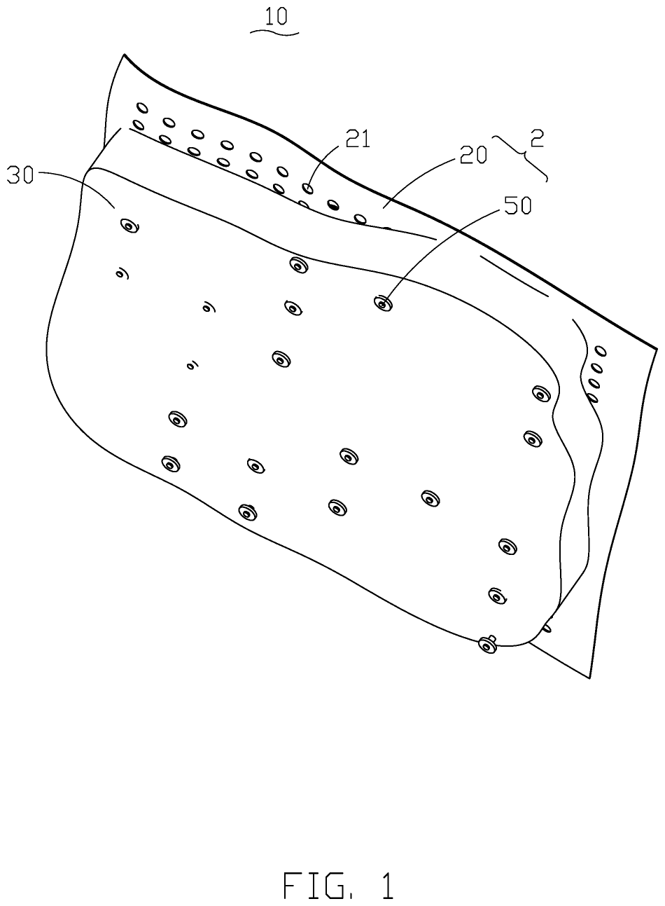

Referring to FIGS. 1-5, an imitation-shaped lamp 10 according to a first embodiment of the present invention is illustrated, wherein the imitation-shaped lamp 10 comprises a supporting portion 2 and an imitation-shaped portion 30. The imitation-shaped portion 30 is detachably coupled to the supporting portion 2, allowing for a randomly variable outer contour of the imitation-shaped lamp 10. The supporting portion 2 comprises a base 20 and a fixing portion 50 attached to the base 20 and at least partially inserted into the imitation-shaped portion 30.

The imitation-shaped portion 30 is attached to the base 20 in a dispersed and/or clustered manner. The fixing portion 50 is at least partially inserted into the imitation-shaped portion 30 to enhance the structural strength of the imitation-shaped lamp 10 and define the outer contour of the imitation-shaped portion 30. In an alternative embodiment of the invention, a fixing portion can be fully inserted into the imitation-shaped portion.

During the installation of the imitation-shaped lamp 10, spread out the base 20 and attach the imitation-shaped portion 30 to the base 20. Use the fixing portion 50 to ensure that the imitation-shaped portion 30 maintains its desired shape while attached to the base 20. Next, attach the base 20 to a specific-shaped structural component or hang it up, or make it stand on its own to form the desired shape. The specific-shaped structural component can be a wall, ceiling, or a supporting frame with a specific design.

The imitation-shaped lamp 10 is shaped through the imitation-shaped portion 30. The base 20 increases the structural strength of the imitation-shaped portion 30 and can be expanded and attached to the specific-shaped structural component, facilitating the shaping of the imitation-shaped lamp 10. After assembling the imitation-shaped lamp 10, it can be installed on the specific-shaped structural component, allowing for easy and quick disassembly and assembly without causing damage to the walls, ceilings, or other specific-shaped structural components within repairable restricts. Therefore, the imitation-shaped lamp 10 can be easily and quickly shaped, which facilitates its disassembly and assembly.

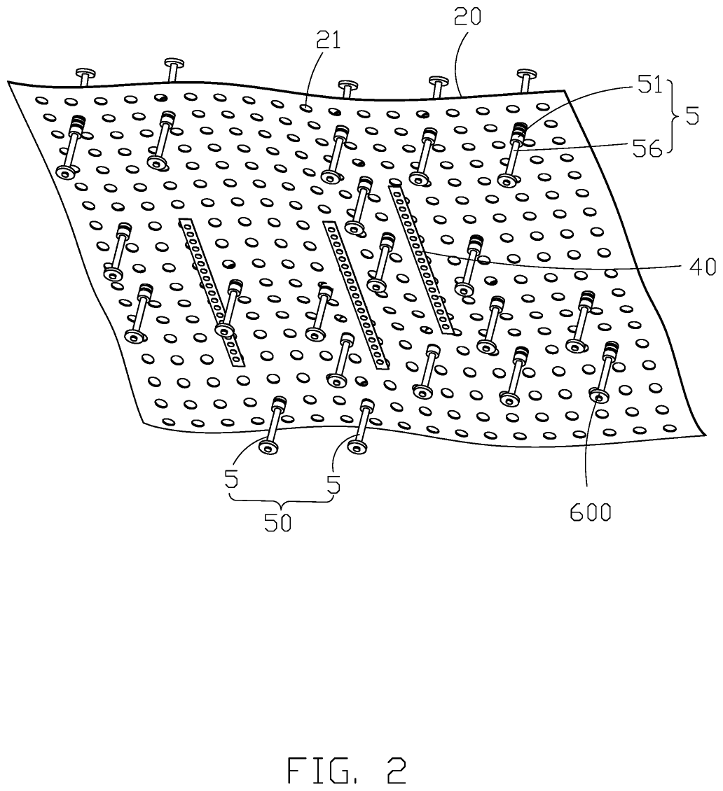

Referring to FIGS. 1 and 2, the imitation-shaped lamp 10 further comprises an illuminating portion 40. The illuminating portion 40 is attached to both the supporting portion 2 and the imitation-shaped portion 30. When the illuminating portion 40 emits light, the emitted light can pass through the imitation-shaped portion 30. In an alternative embodiment of the invention, an illuminating portion 40 can be attached to either the supporting portion 2 or the imitation-shaped portion 30.

During the installation of the imitation-shaped lamp 10, the base 20 is spread out and the illuminating portion 40 and the imitation-shaped portion 30 are attached to the base 20, with the imitation-shaped portion 30 covering the illuminating portion 40. The imitation-shaped portion 30 is attached to the base 20 using the fixing portion 50, ensuring that the imitation-shaped portion 30 maintains its desired shape. Then, the base 20 is attached to the specific-shaped structural component or suspended, or the base 20 stands on its own to form the desired shape.

Referring to FIGS. 1-3, the base 20 can be a flexible sheet-like structure or a flexible linear structure. When the base 20 is a flexible sheet-like structure, it can be made of plastic mesh, fabric, rubber pad, rope net, or metal wire mesh. When the base 20 is a flexible linear structure, it can be a cord, rope, or metal wire.

During the assembly process of the imitation-shaped lamp 10, the illuminating portion 40 can be first secured to the base 20, and then the imitation-shaped portion 30 is attached to the base 20, covering the illuminating portion 40.

In this embodiment, the illuminating portion 40 can be an LED strip, the imitation-shaped portion 30 can be cotton balls or cotton clusters, and the base 20 can be a plastic mesh. The illuminating portion 40 can be secured to the base 20 using zip ties, adhesive tape, or thin ropes.

Once the imitation-shaped lamp 10 is assembled, when the illuminating portion 40 emits light, the emitted light passes through the imitation-shaped portion 30, creating a lighting effect. The illuminating portion 40 can emit monochromatic or multicolored light to enhance the illumination effect of the imitation-shaped lamp 10.

After assembling the imitation-shaped lamp 10, it can be installed on the ceiling, mounted on the wall, or hung to create a large cloud-like effect. It can also be attached to a specific shaped frame to form shapes like animals, plants, or buildings. The base 20 can be molded to achieve an imitation effect, and it can also be trimmed to match the desired contour shape of the imitation-shaped lamp 10.

By fixing the imitation-shaped portion 30 to the base 20, it not only increases the structural strength of the imitation-shaped portion 30 but also keeps it together with the base 20 without scattering. When dismantling the imitation-shaped lamp 10, it is only necessary to remove the base 20 from the ceiling or wall, effectively reducing damage to the ceiling or wall.

First, assemble the imitation-shaped lamp 10 and then install the assembled imitation-shaped lamp 10 on the wall, ceiling, or suspended position. This eliminates the need to work directly on the ceiling or wall, reducing the labor intensity for the staff and making the disassembly and assembly of the imitation-shaped lamp 10 more convenient and efficient.

After dismantling the imitation-shaped lamp 10, the base 20 can be used to maintain a certain structural strength of the imitation-shaped portion 30, allowing the imitation-shaped lamp 10 to be reused. When storing the imitation-shaped lamp 10, the base 20 can be rolled up or folded to protect both the imitation-shaped portion 30 and the illuminating portion 40, reducing the risk of damage during storage.

After dismantling the imitation-shaped lamp 10, it is also possible to separate the imitation-shaped portion 30, the fixing portion 50, and the illuminating portion 40 from the base 20, storing them separately. This allows for the reuse of the base 20, the imitation-shaped portion 30, the illuminating portion 40, and the fixing portion 50 in different occasions. Therefore, the imitation-shaped lamp 10 can be easily and quickly shaped, facilitating the disassembly, storage, and reuse of the imitation-shaped lamp 10.

The imitation-shaped portion 30 can be set on extended surfaces of the base 20 on both sides, making the shape of the imitation-shaped lamp 10 more three-dimensional and diverse.

Referring to FIGS. 1-3, the base 20 comprises a plurality of supporting holes 21, and the fixing portion 50 comprises a plurality of fixing legs 5 inserted into a corresponding supporting hole 21 to restrict the shape of the imitation-shaped portion 30.

By using the fixing legs 5, the imitation-shaped portion 30 is securely attached to the base 20, preventing it from separating and enhancing the overall structural reliability of the imitation-shaped lamp 10. The supporting holes 21 are distributed throughout the base 20, allowing the fixing legs 5 to provide support at multiple points on the imitation-shaped portion 30. This ensures a tighter and more reliable connection between the imitation-shaped portion 30 and the supporting portion 2.

Referring to FIGS. 1-4, each fixing leg 5 comprises a stopper element 51 and a main body 56. The stopper element 51 is installed on the base 20, while the main body 56 is installed on the stopper element 51. When the stopper element 51 mounted on the base 20, the stopper element 51 is inserted into the supporting holes 21 of the base 20.

The imitation-shaped lamp 10 further comprises a restricting portion 60 coupled with the supporting portion 2 and positioned outside the contour of the imitation-shaped portion 30 to restrict the shape of the imitation-shaped portion 30. In this embodiment, the restricting portion 60 comprises a plurality of restricting parts 600. Each restricting part 601 comprises a restricting plate 601 and a through hole 602 drilled completely through the restricting plate 601 for insertion into the main body 56. In an alternative embodiment, the restricting portion is located inside a recessed area of the imitation-shaped portion to restrict the shape of the imitation-shaped portion.

The assembly process of the imitation-shaped lamp 10 is as follows: First, distribute and install the stopper element 51 on the base 20. Then, install the main body 56 onto the stopper element 51. Next, attach the imitation-shaped portion 30 to the base 20 and ensure that the main body 56 at least partly passes through the imitation-shaped portion 30. Finally, install each restricting part 600 onto the corresponding main body 56. Each restricting part 600 of the restricting portion 60 can be positioned outside the contour of the imitation-shaped portion 30 or recessed inside it due to deformation. By using the stopper elements 51, each of the fixing legs 5 of the fixing portion 50 is secured to the base 20. The main bodies 56 further enhance the structural strength of the imitation-shaped portion 30, while the restricting parts 600 of the restricting portion 60 prevent the imitation-shaped portion 30 from detaching from the base 20. This completes the assembly of the imitation-shaped lamp 10, making the installation process convenient and simple. It enables the imitation-shaped lamp 10 to be easily shaped, facilitating disassembly, storage, and reuse.

Each main body 56 can be a flexible wire-like structure. During the assembly process of the imitation-shaped lamp 10, each main body 56 can be threaded through the imitation-shaped portion 30 and used to hold it in place, preventing it from detaching from the base 20.

After passing through the imitation-shaped portion 30, the end of each main body 56 can be tied or knotted, creating a loop to restrict the movement of the imitation-shaped portion 30. Alternatively, each restricting part 600 of the restricting portion 60 can be attached to the corresponding end of the main body 56 through binding or fusion, providing restriction to the imitation-shaped portion 30. It is also possible to tie the ends of different main bodies 56 together at various positions, allowing them to interconnect and provide restriction to the imitation-shaped portion 30.

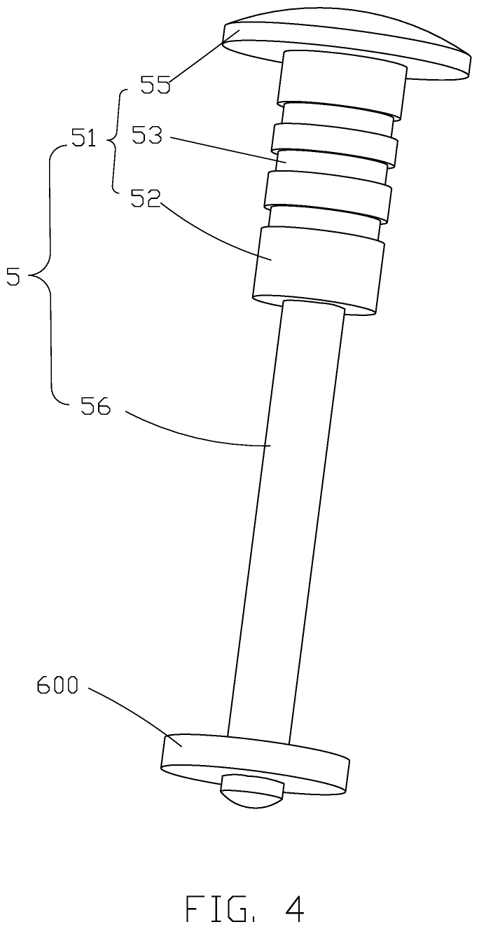

Referring to FIG. 4, the main body 56 is rod-shaped. By setting the main body 56 as the rod-shaped, it facilitates threading through the imitation-shaped portion 30 and reduces the risk of the main body 56 getting caught on the imitation-shaped portion 30, making the disassembly and assembly of the imitation-shaped lamp 10 more convenient and efficient. The main body 56 is integrally formed with the stopper element 51. The stopper element 51 is connected with the base 20, providing support to the imitation-shaped portion 30 through each main body 56. The restricting portion 60 is used to restrict the movement of the imitation-shaped portion 30. This prevents relative sliding between the imitation-shaped portion 30 and the main body 56, thus increasing the overall structural reliability of the imitation-shaped lamp 10. By integrating the main body 56 with the stopper element 51, the structural strength of the fixing portion 50 is improved, and the installation convenience is enhanced. This ensures a more reliable attachment of the imitation-shaped portion 30 to the base 20, further enhancing the overall structural reliability of the imitation-shaped lamp 10.

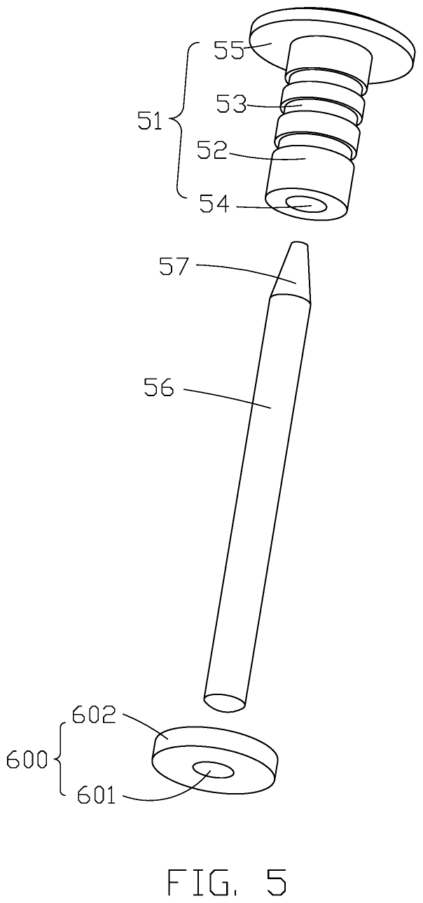

In an alternative embodiment of the present invention, referring to FIG. 5, each main body 56 is installed onto the corresponding stopper element 51. Each stopper element 51 comprises a fastening hole 54, which is designed to have an interference fit with the corresponding main body 56. During the installation process of each main body 56 onto the corresponding stopper element 51, the main body 56 is inserted into the corresponding fastening hole 54. The interference fit between the main bodies 56 and the stopper elements 51 ensures a tight and secure connection, preventing any loosening of each of the fixing legs 5.

The restricting portion 60 is ring-shaped. Each main body 56 has an interference fit with each through hole 602 of the restricting portion 60. This ensures a tight and secure connection between each main body 56 and the corresponding restricting part 600, preventing any relative sliding between them. By using the ring-shaped restricting portion 60, the imitation-shaped portion 30 is restricted, preventing any relative sliding between the imitation-shaped portion 30 and the main body 56, thereby enhancing the overall structural reliability of the imitation-shaped lamp 10.

The restricting portion 60 can be a ring-shaped silicone pad, and the inner diameter of the through hole 602 in each restricting part 600 is smaller than the diameter of the main body 56. When each restricting part 600 is fitted onto the corresponding main body 56, the elasticity of the inner ring of each restricting part 600 securely holds the main body 56, ensuring a fixed relative position between each restricting part 600 and the corresponding main body 56. This, in turn, restricts the movement of the imitation-shaped portion 30 through the restricting portion 60, preventing any relative sliding between the imitation-shaped portion 30 and the main body 56, thus improving the overall structural reliability of the imitation-shaped lamp 10.

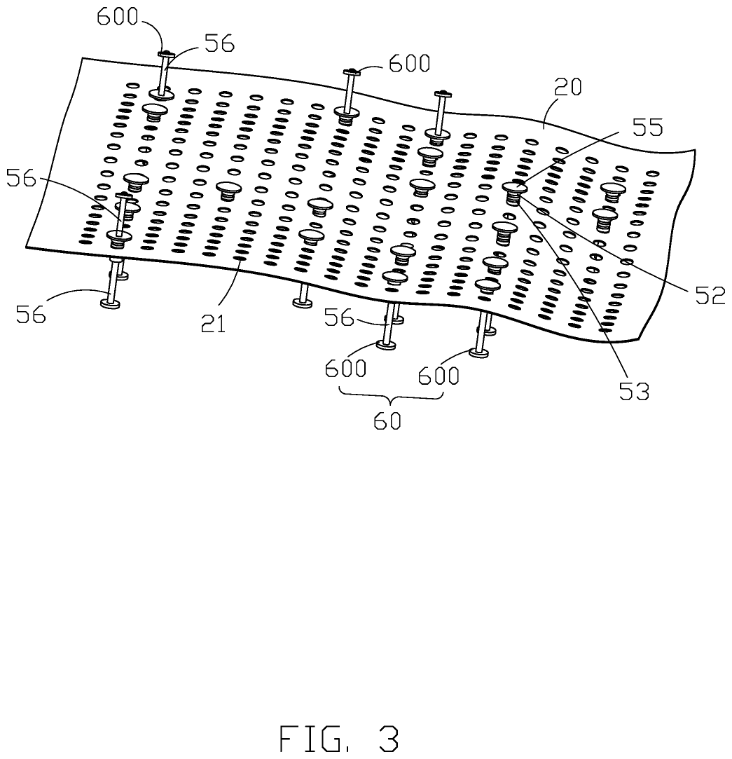

Referring to FIG. 3, the imitation-shaped portion 30 may be positioned on the extended surfaces on both sides of the base 20 to give the imitation-shaped lamp a more three-dimensional and rich appearance. Some of the fixing legs 5 comprises a stopper element 51 and a pair of main bodies 56 attached on both sides of the stopper element 51. During the installation process of each main body onto the corresponding stopper element, the main body 56 is inserted into the corresponding supporting hole 21, which can be a through hole. This allows each main body 56 to extend through the base 20 and arrange on both sides of the base 20, enabling them to provide support to the imitation-shaped portion on the both sides of the base 20. The restricting portion 60 can be set at both ends of the main bodies 56, ensuring reliable attachment of the imitation-shaped portion to the base 20 on both sides.

Referring to FIGS. 4 to 5, an end portion of the main body 56 is a chamfered portion 57. The diameter of the chamfered portion 57 becomes smaller than the diameter of the fastening hole 54. This allows for smoother insertion of each main body 56 into the fastening hole 54 of the corresponding stopper element 51, making the assembly process of the imitation-shaped lamp 10 more convenient and efficient.

Referring to FIGS. 1-3, the base 20 is mesh-like, and each stopper element 51 comprises a cylinder portion 52 and a seating portion 55. The diameter of the cylinder portion 52 tightly fits the corresponding supporting hole 21 of the base 20, while the diameter of the seating portion 55 is larger than the diameter of the corresponding supporting hole 21. In an alternative embodiment, the cylinder portion can be omitted and each main body is directly coupled with a seating portion of each stopper element. The diameter of the seating portion is larger than the diameter of the corresponding supporting hole. The diameter of the main body is equal to the diameter of the seating portion.

After installing the stopper element 51 onto the base 20, the tight fit between the cylinder portion 52 and the supporting holes 21 ensures a secure connection between the stopper element 51 and the base 20. The larger diameter of the seating portion 55 prevents the stopper element 51 from passing through the corresponding supporting hole 21 of the base 20, reducing the risk of the stopper element 51 falling off from the base 20 and improving the overall structural reliability of the imitation-shaped lamp 10. With this tight fit installation method, the stopper element 51 can be easily installed or removed from the base 20 by a plug-and-play approach, making the disassembly and assembly of the imitation-shaped lamp 10 more convenient and efficient.

Referring to FIGS. 4 and 5, the outer wall of the cylinder portion 52 is provided with a groove 53. By engaging the groove 53 with the edge of the corresponding supporting hole 21, the risk of the stopper element 51 falling off from the base 20 is further reduced, thereby enhancing the overall structural reliability of the imitation-shaped lamp 10.

In some embodiments of present invention, the imitation-shaped portion 30 can be made of foam, sponge, cotton wool/cotton clusters, or sprayed cotton in various combinations. The material of the imitation-shaped portion 30 is deformable and easily separable, making it easy to process and shape. This allows for convenient and quick formation of the shape of the imitation-shaped lamp 10 and facilitates the disassembly and assembly of the imitation-shaped lamp 10.

The base 20 is a plastic mesh, the stopper element 51 is a “T” shaped pipe, the main body 56 is a bamboo skewer, the restricting portion 60 is a rubber ring, the imitation-shaped portion 30 is a cotton ball or cotton clusters, and the illuminating portion 40 is an LED strip. The light emitted by the illuminating portion 40 can be monochromatic or multicolored.

The cylinder portion 52 of each stopper element 51 tightly fits the corresponding supporting hole 21 of the base 20, while the diameter of the seating portion 55 of each stopper element 51 is larger than the diameter of the corresponding supporting hole 21 of the base 20. Each main body 56 has an interference fit with the corresponding fastening hole 54 of the stopper element 51, and the through hole 602 of the corresponding restricting part 600 has an interference fit with the corresponding main body 56.

During the assembly process of the imitation-shaped lamp 10, the base 20 can be first spread out and laid flat. Then, the stopper element 51 is installed onto the base 20, dispersing it in the desired positions on the base 20. Next, each main body 56 is inserted into the corresponding fastening hole 54 of each stopper element 51. The illuminating portion 40 is then secured to the base 20 by tying or binding it. Afterwards, the imitation-shaped portion 30 is attached to the base 20, with the main body 56 at least partly passing through it, providing coverage for the illuminating portion 40. The restricting portion 60 is then installed onto the corresponding main body 56 to restrict the movement of the imitation-shaped portion 30 and prevent it from detaching from the base 20. Finally, the contour and undulation shape of the imitation-shaped portion 30 are shaped to meet the expected requirements for the shape of the imitation-shaped lamp 10.

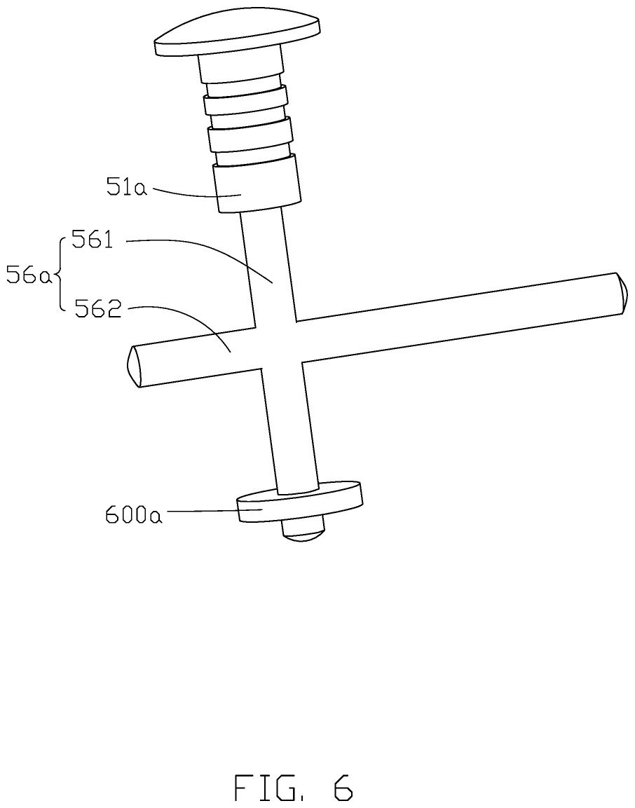

Referring to FIG. 6, a second embodiment is similar to the first embodiment of the present invention except that: a main body 56a is provided with at least one branch. The main body 56a comprises a first branch 561 and a second branch 562 interlaced with the first branch 561. One end of the first branch 561 is connected with a stopper element 51a and another end of the first branch 561 is coupled with a restricting part 600a. The branched main body 56a expands the support range of the main body 56a. This not only saves materials and reduces production costs but also simplifies the assembly process of the imitation-shaped lamp.

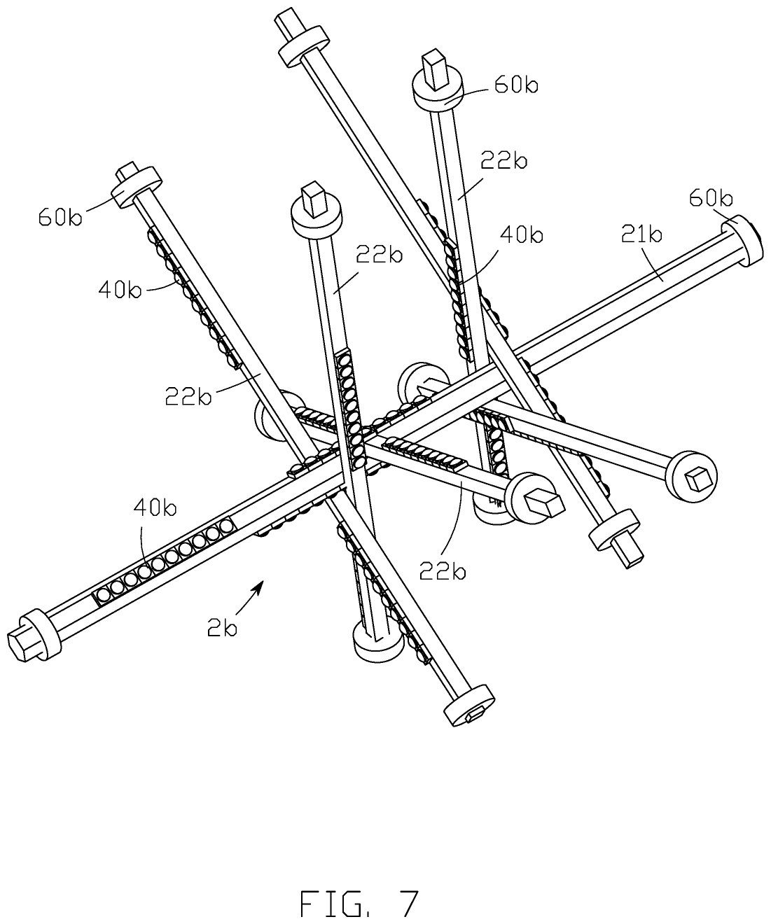

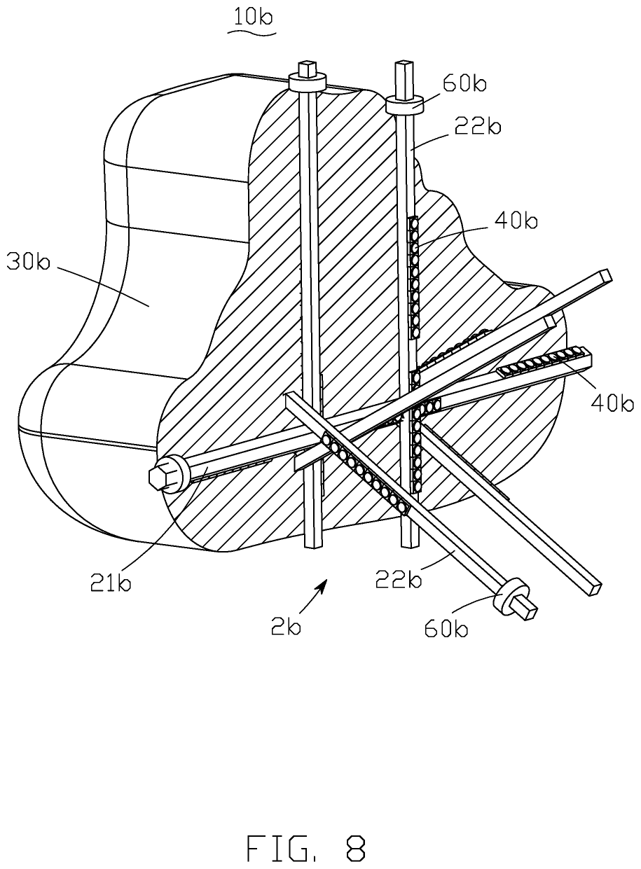

Referring to FIGS. 7-8, a third embodiment is similar to the first embodiment of the present invention except that a structure of a supporting portion 2b.

In this embodiment, an imitation-shaped lamp 10b comprises the supporting portion 2b, an imitation-shaped portion 30b attached on the supporting portion 2b, an illuminating portion 40b attached to the supporting portion 2b, and a restricting portion 60b coupled with the supporting portion 2b and located outside the contour of the imitation-shaped portion 30b to restrict the shape of the imitation-shaped portion 30b.

The supporting portion 2b includes a first supporting arm 21b and a plurality of second supporting arms 22b mounted on the first supporting arm 21b, respectively. The first supporting arm 21b is interlaced with each of the second supporting arms 22b.

With the interlaced arrangement of the first supporting arm 21b and the second supporting arms 22b, the supporting portion 2b is formed into a three-dimensional shape to serve as a skeleton of the imitation-shaped lamp 10b. By defining the parameters such as the length of the first supporting arm 21b and the second supporting arms 22b, the plurality of the second supporting arms 22b, the angle between the second supporting arms 22b and the first supporting arm 21b, the installation position of the second supporting arms 22b on the first supporting arm 21b, or the extended length of the second supporting arms 22b from the first supporting arm 21b, the shape of the supporting portion 2b can be achieved. This allows the supporting portion 2b, as a skeleton of the imitation-shaped lamp 10b, to support the imitation-shaped portion 30b and form the desired cloud-like shape of the imitation-shaped lamp 10b. Consequently, the preliminary shaping of the imitation-shaped lamp 10b is completed, which enhances the efficiency of shaping with the imitation-shaped portion 30b and reduces the work intensity of the shaping personnel.

By shaping the imitation-shaped lamp 10b through the supporting portion 2b, and then attaching the imitation-shaped portion 30b to the supporting portion 2b, shaping personnel only need to attach the imitation-shaped portion 30b (such as cotton, foam, etc.) to the supporting portion 2b using adhesive or other methods to form the cloud-like appearance of the imitation-shaped lamp 10b. After shaping, only minimal fine-tuning is required to make the imitation-shaped lamp 10b more in line with the desired requirements, thereby forming a cloud-shaped lamp. This avoids the need for shaping the cloud-like appearance directly from the imitation-shaped portion 30b, which would require higher shaping skills from the personnel and multiple adjustments to the shaping of the imitation-shaped lamp 10b. This, in turn, increases the labor intensity of the shaping personnel and reduces production efficiency.

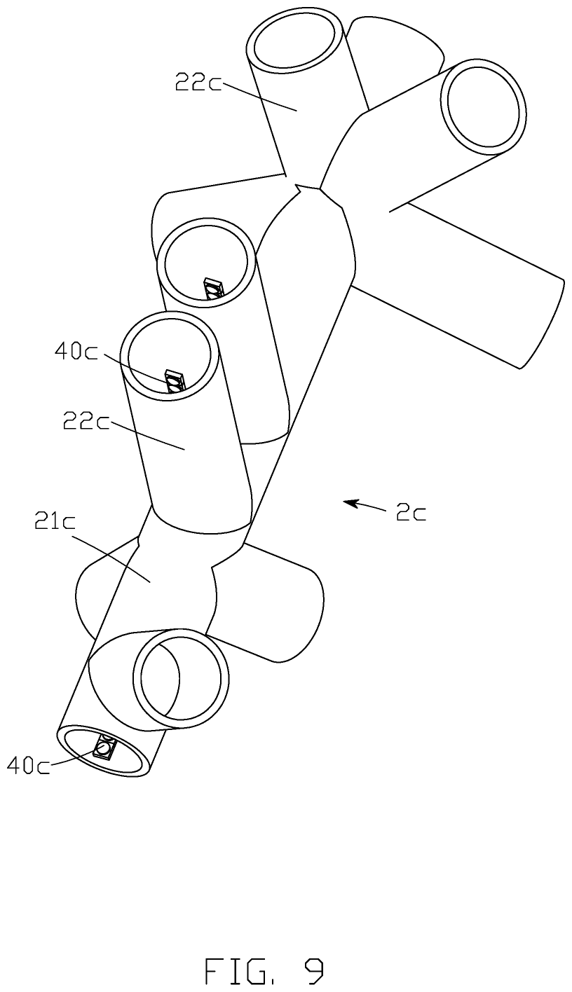

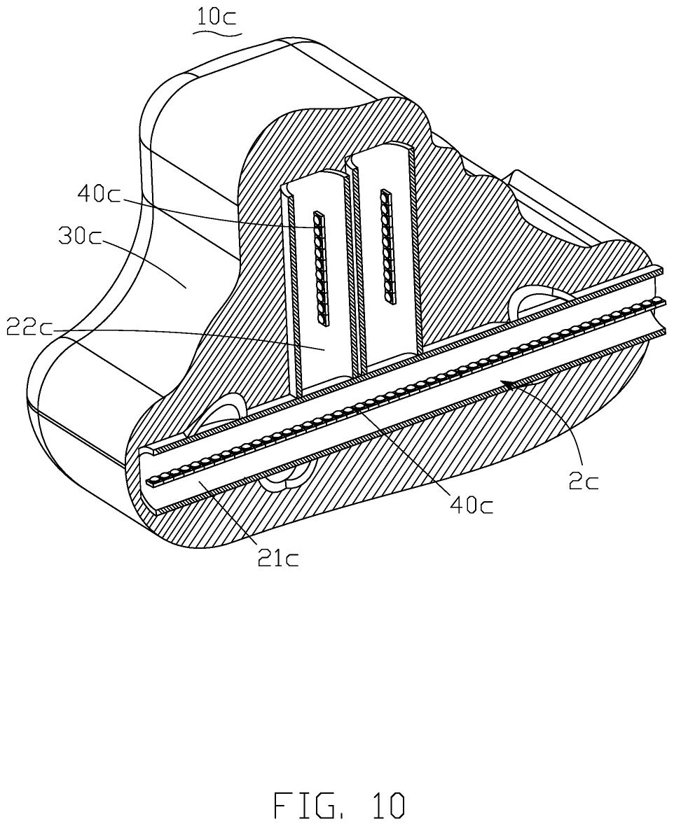

Referring to FIGS. 9 and 10, a fourth embodiment is similar to the third embodiment of the present invention except that: a structure of a supporting portion 2c.

An imitation-shaped lamp 10c comprises a supporting portion 2c, an imitation-shaped portion 30a directly coupled with the supporting portion 2a, an illuminating portion 40, and a restricting portion 60a coupled with the supporting portion 2a and located outside the contour of the imitation-shaped portion 30a to restrict the shape of the imitation-shaped portion 30a.

The supporting portion 2a comprises a first supporting arm 21c and a plurality of second supporting arm 22c, both of which are attached to an illuminating portion 40c. By designing the shape of the first supporting arm 21c and configuring the plurality of second supporting arms, the supporting portion 2a preliminarily shapes the imitation-shaped lamp 10a, thereby improving the efficiency of shaping. Both the first supporting arm 21c and the second supporting arm 22c can be hollow structures, increasing the occupied space of the supporting portion 2c and further reducing the usage of the imitation-shaped portion 40c, thus lowering production costs.

When the imitation-shaped lamp 10c is assembled, it can be installed on the ceiling using nails or a pulley system to create a cloud-like appearance. When the illuminating portion 40c emits light, it creates a glowing cloud effect for the imitation-shaped lamp 10c. The position of the illuminating portion 40c can be designed to control the desired lighting effect, creating a three-dimensional and harmonious shape for the imitation-shaped lamp 10c through the manipulation of light and shadow. If the illuminating portion 40c consists of a colored LED strip, the imitation-shaped lamp 10c can display a colorful cloud effect, adding richness to its overall appearance.

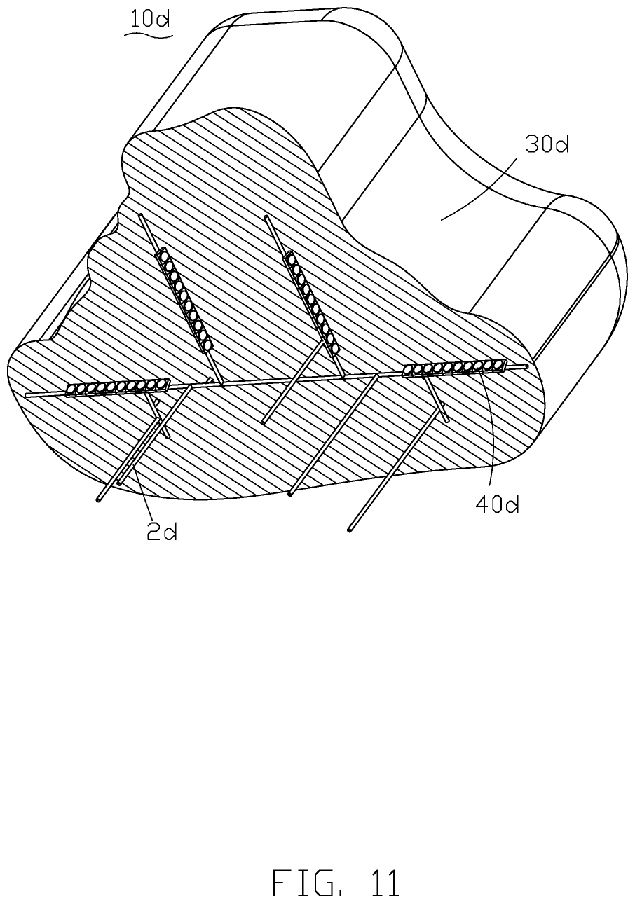

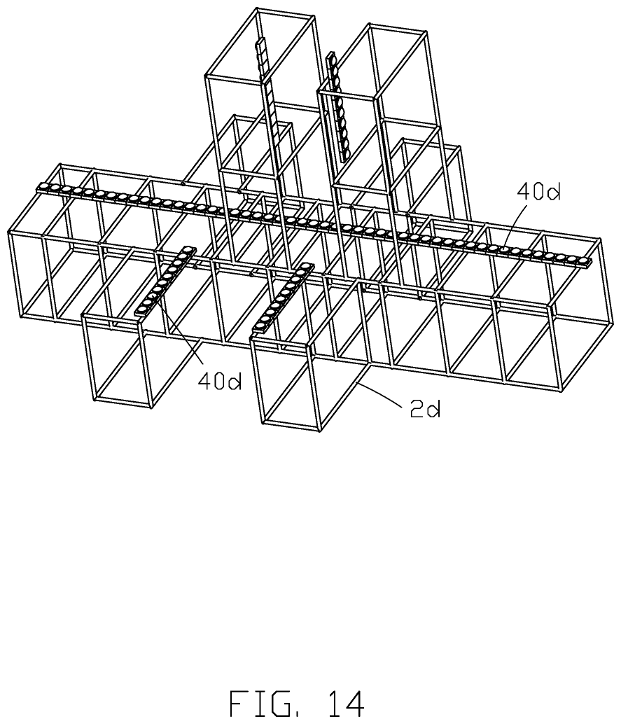

Referring to FIGS. 11 and 14, a fifth embodiment is similar to the first embodiment of the present invention except that: the material of the supporting portion 2d is a shapeable wire-like object. By bending or joining, the supporting portion 2d is shaped to provide initial form to the imitation-shaped lamp 10d.

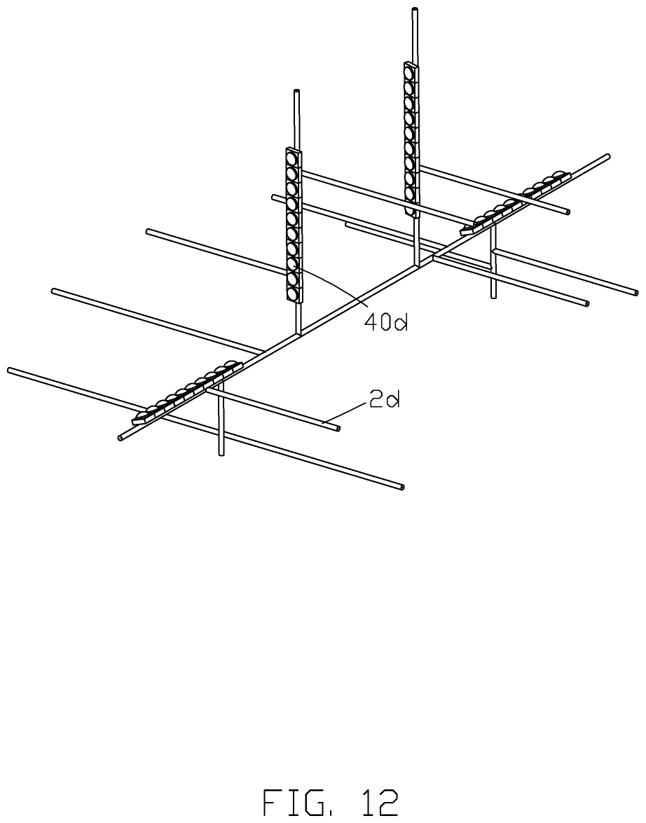

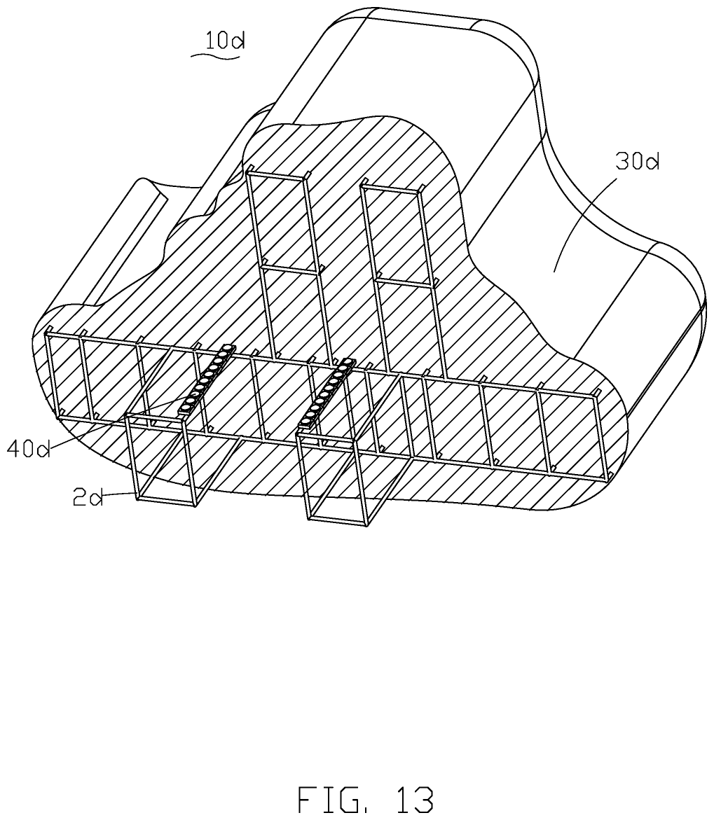

When shaping the supporting portion 2d, it can be formed into a branched three-dimensional structure (as shown in FIGS. 11 and 12), where an imitation-shaped portion 30d is attached to the branches of the supporting portion 2d and an illuminating portion 40d is attached to both the supporting portion 2d and the imitation-shaped portion 30d. Alternatively, the supporting portion 2d can be formed into a three-dimensional framework structure (as shown in FIGS. 13 and 14), where the illuminating portion 40d is installed inside the supporting portion 2d.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An imitation-shaped lamp, comprising:
a supporting portion;
an illuminating portion;
an imitation-shaped portion detachably coupled at the supporting portion for forming an outer contour of the imitation-shaped lamp, and at least partially covering the illuminating portion;
wherein the supporting portion is at least partially located inside the imitation-shaped portion, in order to increase the structural strength of the imitation-shaped portion and shape the outer contour of the imitation-shaped portion.

2. The imitation-shaped lamp as claimed in claim 1 further comprising a restricting portion coupled with the supporting portion, and the restricting portion is located outside the contour of the imitation-shaped portion to restrict the shape of the imitation-shaped portion.

3. The imitation-shaped lamp as claimed in claim 2, wherein the restricting portion is movably connected to the supporting portion and moves relative to the supporting base.

4. The imitation-shaped lamp as claimed in claim 1, wherein the supporting portion comprises a base and a fixing portion connected to the base and at least partly inserted into the imitation-shaped portion.

5. The imitation-shaped lamp as claimed in claim 4, wherein the base comprises a plurality of supporting holes, and the fixing member comprises a plurality of fixing legs inserted into a corresponding supporting hole.

6. The imitation-shaped lamp as claimed in claim 5, wherein each of the fixing legs comprises a stopper element inserted into the corresponding supporting hole of the base and a main body coupled with the stopper element for supporting the imitation-shaped portion.

7. The imitation-shaped lamp as claimed in claim 6, wherein some of the fixing legs comprises a stopper element and a pair of main bodies attached on both sides of the stopper element.

8. The imitation-shaped lamp as claimed in claim 7, wherein the imitation-shaped portion is positioned on both sides of the base.

9. The imitation-shaped lamp as claimed in claim 6, wherein the stopper element comprises a fastening hole and an end portion of the main body is a chamfered portion inserted into the fastening hole.

10. The imitation-shaped lamp as claimed in claim 6, wherein the stopper element comprises a cylinder portion and a seating portion, the diameter of the cylinder portion fits the corresponding supporting hole of the base, while the diameter of the seating portion is larger than the diameter of the corresponding supporting hole.

11. The imitation-shaped lamp as claimed in claim 10, wherein the outer wall of the cylinder portion is provided with a groove for engaging with an edge of the corresponding supporting hole.

12. The imitation-shaped lamp as claimed in claim 6, wherein the main body is integrally formed with the stopper element.

13. The imitation-shaped lamp as claimed in claim 1, wherein the base has a mesh-like structure.

14. The imitation-shaped lamp as claimed in claim 1, wherein the supporting portion comprises at least two second supporting arms and a first supporting arm interlaced with each of the second supporting arms.

15. The imitation-shaped lamp as claimed in claim 1, wherein the supporting portion comprises a hollow structure and the illuminating portion received in the hollow structure.

16. The imitation-shaped lamp as claimed in claim 1, wherein the imitation-shaped portion can be made of foam, sponge, cotton, or sprayed cotton in various combinations.

17. The imitation-shaped lamp as claimed in claim 1, wherein the imitation-shaped portion creates a cloud-like appearance.
